(19) United States
(12) Patent Application Publication
(10) Pub. No.: US 2015/0340758 A1
(43) Pub. Date: Nov. 26, 2015

(54) STICK-ON MULTI-FREQUENCY WI-FI (Backpack and Helmet) ANTENNA

(71) Applicants: GARY GWOON WONG, TORRANCE, CA (US); CALVIN GWOON WONG, TORRANCE, CA (US); PERRY GWOON WONG, TORRANCE, CA (US); KALEM GWOON WONG, TORRANCE, CA (US)

(72) Inventors: GARY GWOON WONG, TORRANCE, CA (US); CALVIN GWOON WONG, TORRANCE, CA (US); PERRY GWOON WONG, TORRANCE, CA (US); KALEM GWOON WONG, TORRANCE, CA (US)

(21) Appl. No.: 14/284,393

(22) Filed: May 22, 2014

(51) Int. Cl. H01Q 1/27; H01Q 9/28

(52) U.S. Cl. CPC H01Q 1/276; H01Q 1/273; H01Q 9/285

(57) ABSTRACT

This invention discloses a design and implementation of a high performance broadband antenna for backpack and helmet application allowing data, video, and voice transmission between parties. The subject antenna consists of a pair of triangle shape elements which are configured to stick on a backpack surface or place over a helmet with a coaxial cable connecting the radiating structure to the communication equipment on the body. A metal shielding surface is employed and the shielding surface performs as a ground Wane and also acts as a protectant from radiation hazards to the head or body areas. The antenna is made with materials that are accommodating and can easily conform to the shape of a helmet or sticking directly onto the backpack surface. This innovative design can function under multiple frequencies on UHF and S bands; its placement on a helmet receives less interference from its surroundings.

### CROSS-REFERENCE TO RELATED APPLICATION

This application claims the benefit of U.S. Provisional Application US 61/956,025, dated May 31, 2013.

### FIELD

This disclosure provides new art in design and fabrication of antenna structures that are configured to stick onto a top of a helmet or onto a backpack outer surface in performing Wi-Fi communication.

The radiating elements of the helmet and backpack stick-on antenna structures are configured after the patent application Ser. No. 13/200,521 antenna structure in which the triangular radiating elements are excited by a coaxial cable over the top of the radiating structures.

### SUMMARY OF THE INVENTION

A new design and implementation of a high performance broadband antenna configured for Wi-Fi application is disclosed. The antenna is designed for communication systems allowing data, video, and voice transmission between parties. The invention antenna consists of a pair of triangle shape elements which are made to fit over a helmet or simply stick onto a backpack. The triangular elements are positioned in such a way that their vertex angles are pointing at one another and are excited by a coaxial cable which runs along the center. The outer shield of the coaxial cable is electrically connected to one side of the radiating element and the center conductor is connected to the opposing side of the radiator. A gap approximately ⅜ inches is maintained. The connection in this manner forms a unique infinite balun (balanced-to-unbalanced converter) in obtaining a good impedance response over a wide frequency band. Special attention has been given to the design to ensure that harmful radiation will not be occurred. Thus a metal shield is implemented. The function of the shield is to direct harmful radiation away from the head and body area. The shield is also function as a ground plane for the radiating element. The separation distance between the radiating element and its ground plane is about 0.1 wavelengths. A prototype model has been made and tested; the electrical performance of this disclosure has performed as stated.

The preferred embodiment additionally comprises a pair of broad band triangle shape elements which are symmetrically excited by a coaxial cable in a unique way and additional matching device is not required.

The preferred embodiment structure is extremely broad band because of the element design along with its excitation. For high frequencies, the radiator is resonated near the apex, and for low frequencies the radiator is resonated near the far end of the triangle element.

The preferred embodiment structure vertex angle is 90 degrees and the base angles of the radiating element are 45 degrees for stick-on helmet antenna and also a 90 degrees vertices angle and 45 degrees base angle for stick-on backpack radiating element. A small change of angles may be employed which will not alter the physical and impedance characteristics of the antenna appreciably. The antenna design is not sensitive to dimensional tolerance.

The preferred embodiment radiating element consist a pair of unique triangle shape metal surfaces that are positioned over a metal conducting ground plane to be stick onto the helmet or stick onto the backpack surface directly.

The preferred embodiment backpack stick-on antenna is protected by a cover and the cover surface can be decorated with colorful words or figures of personal preference.

The coaxial cable of the preferred embodiment is terminated with a mating connector which is connecting to the electronic equipment.

The preferred embodiment structure is made with materials that is easily conform and fit over a helmet as well as to the backpack. A stick-on feature can be obtained with the application of Velcro material.

The preferred embodiment provides a hemispherical coverage pattern when the radiating structure is located on helmet or on a backpack surface.

The preferred embodiment structure can function under multiple frequencies on UHF and S frequency bands.

The preferred embodiment having the radiating element on the top of a helmet in such a way it will receive less interference from its surroundings.

The preferred embodiment structure is passive and external power is not required.

The preferred embodiment structure does not require frequency turning or adjustment.

The preferred embodiment structure can be configured to operate over a frequency band of 800 MHz to 5000 MHz.

The preferred embodiment of backpack or helmet design can be shared by two Wi-Fi systems of good frequency separation. This is accomplished by employing a circulator and a filter to route signals to its respective terminal. A wide frequency separation allows the filter to be configured in a simple way in a form of a high or low pass filter.

Another preferred embodiment of claim 1 consisting: a vertical and a horizontal radiating element (FIG. 3) along with a hybrid device that are connecting in such a way that both left and right circular polarizations are provided.

### DETAIL DESCRIPTION

The subject invention antenna consists of a pair of unique shape triangular elements which are excited by a coaxial cable symmetrically to form the unique input balun (balanced-to-unbalanced converter). The balun is extremely broad band.

The radiating element is operating over a metallic surface. The function of the metal surface is to help reflect radiation energy away from the head or body of a person operating the apparatus and also functioning as a ground plane for the radiating structure to provide the desired hemispherical radiation pattern.

Antenna Radiating Element Design

The radiating element is the most critical part of this invention. Conventional antenna approach in backpack, the antennas are whip designs of various heights and these designs lack of broad band performance. As a result, multiple whip radiators are often employed in a system involving multiple frequencies.

The invention antenna describes here is composed two triangular surfaces that are positioned facing one another, see FIG. 1. The preferred vertex angles are 90° and the base angles are 45°. The tips are separated about 3/8 of an inch. The arm length is about 3 inches on the backpack stick- on design and the curve length of the triangular radiator arms on the helmet design are also approximately 3 inches.

FIG. 1 shows the radiating element excited symmetrically by a coaxial of RG58/U or similar. With the exterior jacket removed, the outer shield of the cable is electrically connected to the input side of the triangular radiator. The center conductor is electrically connected to the conjugated side through the apex. The coaxial cable can be soldered, spot welded, or mechanically fastened to the radiating element for good electrical connection. The coaxial cable is terminated with a connector mating to the electronic equipment.

The radiating structure is designed such that it can easily place over the helmet.

The Radiating element can also function by simply sticking onto the outer surface of the backpack.

Antenna Ground Plane

The main purpose of the antenna metal shield is to prevent harmful radiation to the head and body areas of a person and has also performed well for the radiator in obtaining good radiation coverage. The ground plane is configured to be placed over the hat or helmet and is made of flexible materials such as fine meshes of metal. It is protected by a waterproof cover. The stick on feature is obtained via Velcro material.

Antenna Coverage Pattern

The radiation coverage pattern of the disclosure antenna on a helmet is hemispherical and the polarization is predominantly vertical. A horizontal component is present when the operating frequencies are nearing the high end of the frequency band. The polarization of the backpack stick on antenna is linear vertical and the coverage pattern is also hemispherical.

### DRAWINGS

FIG. 1—Backpack Antenna

FIG. 1 presents a plane view of the stick-on antenna design. The vertex angle 1 is 90° and the base angles 2 are 45°. The height of the antenna element 3 including the gap is 6⅜ inches. The antenna element width 4 is 6⅜ inches. The coaxial cable 5 is soldered to the triangle shape radiating elements 6. The coaxial cable is terminated with a connector 7, mating to the connector of the electronic equipment. The location 8 is the ⅜ inches gap. The enclosure of the stick-on radiator is 9. A small change of angles and dimensions will not alter the general performance of the antenna.

FIG. 2—Helmet Antenna

FIG. 2 presents a prospective view of a helmet antenna. The curve triangle shape radiating element 10 is located on the top of the helmet and radiating over the fine mesh metal ground plane 11 which covers the dome part of the helmet. The element design is identical to FIG. 1 and having a shape fits over a helmet. The vertex angle 10a and base angles 10b are 90 degrees and 45 degrees.

FIG. 3—Circular Polarization Backpack Antenna

FIG. 3 presents a plane view of a circular polarization stick-on antenna. Two sets of radiating elements 12 and 13 are positioned orthogonal to one another in the same square aperture 14 of 6⅜ inches sides. The radiating element dimensions are identical to FIG. 1 measurements. The coaxial cables 15, connecting the 90 degrees hybrid coupler device 15a to the radiating elements, are equal in length. The input ports 16 and 17 of the 90 degrees hybrid coupler are the left and right hand transmitting and receiving ports of the communication system and simultaneous transmission and receiving of left and right hand signals are provided.

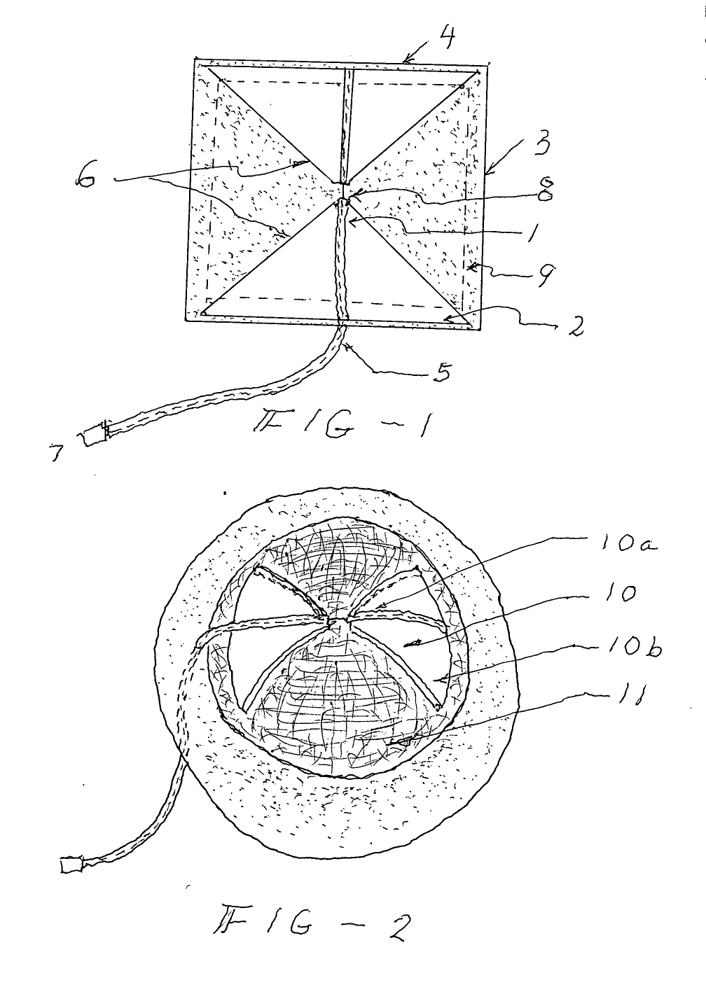

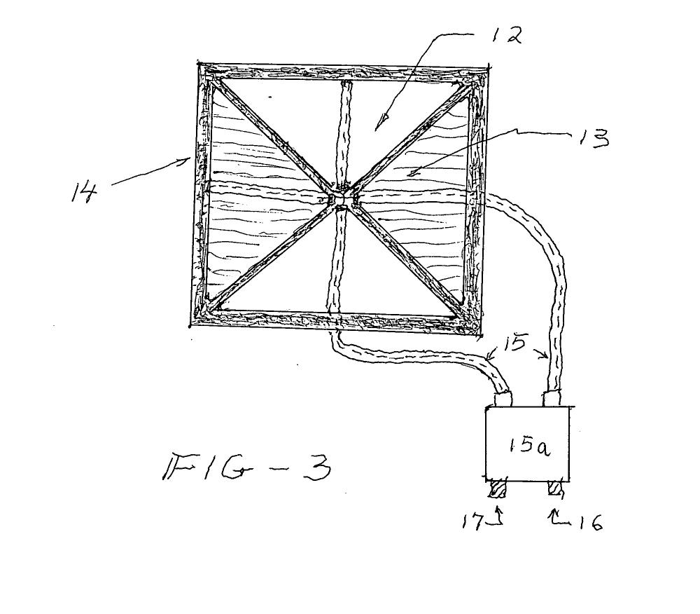

1. An antenna structure comprising: a pair of radiating polygonal radiator positioned such that one is opposing other along the vertex, a coaxial cable positioned such that its runs along the two reflecting vertices characterized in that the coaxial center conductor has a gap separating it in two parts at the location where the two vertices meet, one part of the center conductor is electrically connected to one radiating element and the center conductor is electrically connected to the conjugate. radiating element forming an infinite baler, and the entire structure is protected by a cover which is configured to stick onto the outer surface of a backpack or on the top of a helmet.

2. The preferred embodiment of claim 1 triangle radiating element pair whose vertices angles are 90 degrees and the base angles are 45 degrees.

3. The preferred embodiment of claim 1 whose isosceles arms lengths are 3.9 inches.

4. The preferred embodiment as defined in claim 1 wherein a conductance ground plane of square shape and having a planar contour is located approximately 0.2 inches behind the radiating elements of the backpack antenna.

5. The preferred embodiment as defined in claim 1 wherein a conductance ground plane of circular shape and having a convex contour is located 0.2 inches behind the radiating elements of the helmet antenna.

6. The antenna structure of claim 1 coaxial cable is terminated with a mating connector connecting to the electronic devices.

7. Another preferred embodiment of claim 1 consisting two sets of radiating elements that are positioned orthogonal to each other.

8. The radiating elements of claim 7 further connecting to a 90 degrees hybrid coupler device.

9. The connecting coaxial cables of claim 8, connecting the radiating elements to the hybrid device, are equal in lengths.

10. The output ports of the claim 8 hybrid coupler device which are connecting to the orthogonal radiating elements via the equal length coaxial cables while the input ports of the hybrid coupler became the transmitting and receiving ports of the circular polarization right and left system.
